(19) United States
(12) Patent Application Publication
(10) Pub. No.: US 2022/0251245 A1
(43) Pub. Date: Aug. 11, 2022

(54) PROCESS FOR PRODUCING A CELLULOSIC FUNCTIONAL FIBRE WITH HIGH ION EXCHANGE CAPACITY, CELLULOSIC FUNCTIONAL FIBRE, TEXTILE PRODUCT COMPRISING CELLULOSIC FUNCTIONAL FIBRE, AND GARMENT OR PIECE OF FURNITURE COMPRISING SAID CELLULOSIC FUNCTIONAL FIBRE OR TEXTILE PRODUCT

(71) Applicant: smartfiber AG, Rudolstadt (DE)

(72) Inventor: Axel KOLBE, Rudolstadt (DE)

(73) Assignee: smartfiber AG, Rudolstadt (DE)

(21) Appl. No.: 17/721,104

(22) Filed: Apr. 14, 2022

Related U.S. Application Data
(63) Continuation of application No. PCT/EP2020/079089, filed on Oct. 15, 2020.

(30) Foreign Application Priority Data
Oct. 15, 2019 (DE) 10 2019 007165.4
Apr. 15, 2020 (EP) PCT/EP2020/060630

(51) Int. Cl. C08B 15/02; C08B 1/00; D01F 2/24; D01F 2/08

(52) U.S. Cl. CPC C08B 15/02; D01F 2/08; D01F 2/24; C08B 1/003

(57) ABSTRACT

A process for producing a cellulosic functional fiber having high ion exchange capacity, a cellulosic functional fiber produced by said process, a textile product comprising said cellulosic functional fiber, and a garment or piece of furniture comprising said cellulosic functional fiber and/or said textile product. The cellulosic functional fiber produced is characterized in that it comprises an extracted plant material with polymer-bound uronic acids contained therein.

This nonprovisional application is a continuation of International Application No. PCT/EP2020/079089, which was filed on Oct. 15, 2020, and which claims priority to German Patent Application No. 10 2019 007 165.4, which was filed in Germany on Oct. 15, 2019, and to International Patent Application No. PCT/EP2020/060630, which was filed on Apr. 15, 2020, and which are all herein incorporated by reference.

### BACKGROUND OF THE INVENTION

### Field of the Invention

The present invention relates to a process for producing a cellulosic functional fiber with high ion exchange capacity, a cellulosic functional fiber produced by means of said process, a textile product comprising said cellulosic functional fiber, and a garment or piece of furniture comprising said cellulosic functional fiber and/or said textile product.

### Description of the Background Art

Cellulosic fibers can be made artificially from cellulose. In terms of technology, such cellulosic fibers are produced as regenerated fibers, the main representatives of which are rayon, modal, lyocell and cupro. Lyocell is a cellulose regenerated fiber, which is produced according to the so-called lyocell process, a direct dissolving process with N-Methylmorpholine-N-oxide Monohydrate (NMMO) as a solvent. Cellulosic fibers, which are produced according to the lyocell process, have excellent physical properties that make it possible to integrate significant proportions of foreign materials into a textile fiber.

These foreign materials may be, among other things, other polysaccharides, such as cellulose derivatives, chitin, xylan or starch, wherein uronic acid-containing polysaccharides have proven to be particularly interesting. These cellulosic fibers can be used, among other things, in medicine, in water treatment, and in functional wear. As monomers and oligomers, uronic acids are completely unsuitable as a material for textile fibers because they are water-soluble.

DE 100 09 034 A1 discloses a process for producing cellulosic molded bodies with reduced, selectively adjustable fibrillation. The process includes the transfer of a suspension of cellulose and aqueous N-methylmorpholine-N-oxide to an extrusion solution, extruding the extrusion solution through a molding tool and through an air gap into a spinning bath, and the washing and crosslinking of the precipitated molded body, wherein further an oxidized secondary polysaccharide is used, and the cellulose is crosslinked with the oxidized secondary polysaccharide. Water-soluble homopolysaccharides and heteropolysaccharides can be used as secondary polysaccharides, wherein examples of heteropolysaccharides include pectin and algin.

WO 2001/062844 A1, which corresponds to US 2003/0186611, which is incorporated herein by reference, describes a process for producing a molded body with a low tendency to fibrillate. The process comprises (a) the mixing of a biodegradable polymer selected from the group consisting of cellulose, modified cellulose and mixtures thereof with a material from marine plants and/or of shells of marine animals, wherein the material from marine plants and/or from shells of marine animals is present in an amount of 0.1 to 30 wt.-%, calculated on the basis of the weight of the biodegradable polymer, (b) the production of a deformable mass according to the lyocell process, (c) the processing of the mass obtained in (b) into a molded body, and (d) the post-treatment of the produced molded body. The material made from marine plants is preferably selected from the group algae, kelp, and/or seaweed, wherein examples of algae include brown algae, green algae, red algae, blue-green algae, and/or mixtures thereof.

WO 2003/012182 A1, which corresponds to US 2004/0265612 describes a process for producing cellulosic molded bodies with a high retention capacity for aqueous liquids. The process includes producing and extruding a deformable mass according to the lyocell process, wherein the deformable mass contains, in addition to cellulose, a superabsorbent polymer, which is obtained by polymerization of (a) 55 to 99.95 wt.-% monomers carrying monoethylenically unsaturated carboxyl groups, (b) 0.05 to 5.0 wt.-% of at least one crosslinking agent, (c) 0 to 40 wt.-% of further monomers that are co-polymerizable with (a), and (d) 0 to 30 wt.-% of a water-soluble graft base. The graft base can be made of, among other things, partially or fully hydrolyzed polyvinyl alcohols, polyacrylic acids, polyglycols and polysaccharides, wherein as a concrete example of polysaccharides, cellulose derivatives, starch, starch derivatives and xanthans, alginates are also mentioned in addition to cellulose.

CN 103 194 826 A discloses a process for producing a biodegradable composite yarn with antibacterial properties, good moisture absorption and high yarn strength, which, inter alia, can be used to produce clothing. The process comprises opening and cleaning, carding, roving, spinning, and winding of a suitable mixture of 10 to 80 wt.-% of alginate fibers, 10 to 80 wt.-% of silkworm protein-based fibers and 10 to 80 wt.-% of bamboo fibers, wherein the alginate fibers are made from sodium alginate which was previously obtained by extracting seaweed using water as an extractant.

CN 108 065 459 A discloses a process for producing a fabric with good moisture absorption, which is used to produce thermal underwear. The process comprises spinning a mixture of 40 to 60 parts by weight of cotton fibers, 20 to 40 parts by weight of lyocell-bamboo fibers, 30 to 40 parts by weight of modal fibers, 25 to 30 parts by weight of elastane fibers, 25 to 45 parts by weight of alginate fibers and 5 to 15 parts by weight of cashmere, wherein the alginate fibers are made of sodium alginate which was previously obtained by extracting seaweed using water as an extractant.

In general, uronic acid-containing polymers also possess ion-exchanging properties. However, the use of ion-exchanging natural substances for cellulosic functional fibers in the context of a direct dissolving process such as the lyocell process has various disadvantages that make stable process management difficult. In particular, soluble components such as mineral salts and soluble organic substances (e.g., proteins, carbohydrates, lipids, and dyes), accumulate in the circulating operating media (e.g., in solvents such as N-methylmorpholine N-oxide). These unwanted components lead to the decomposition of the solvent or to encrustations or contamination in the system, resulting in a lower production throughput and increased production costs as a result of necessary cleaning measures. In addition, the unwanted components have an adverse effect on the quality of the cellulosic molded body produced.

### SUMMARY OF THE INVENTION

It is therefore an object of the present invention to provide a process for producing a cellulosic functional fiber, which largely avoids the disadvantages described above. In particular, the process should not adversely affect either the solvent cycle or the fiber manufacturing process and should ensure cost-effective and efficient production of cellulosic functional fibers with high ion exchange capacity on the basis of a naturally occurring polymer.

In an example, the invention relates to a process for producing a cellulosic functional fiber, which comprises the steps of: providing a raw plant material that contains polymer-bound uronic acids; extracting the raw plant material using an extractant to provide an extracted plant material containing polymer-bound uronic acids; preparing a spinning solution (dope) comprising cellulose and the extracted plant material containing polymer-bound uronic acids; and spinning the spinning solution.

In a second aspect, the invention relates to a cellulosic functional fiber, which was produced by the process described in the first aspect.

In a third aspect, the invention relates to a textile product comprising the cellulosic functional fiber described in the second aspect.

In a fourth aspect, the invention relates to a garment or a piece of furniture comprising the cellulosic functional fiber described in the second aspect and/or the textile product described in the third aspect.

### DETAILED DESCRIPTION OF THE INVENTION

In the context of the inventive production process, first a raw plant material is provided which contains polymer-bound uronic acids. The term “raw plant material” as used herein can include all naturally occurring plants and plant parts of terrestrial or marine origin, which contain polymer-bound uronic acids and should thus already have a significant ion exchange capacity for cations.

Preferably, the raw plant material is selected from the group consisting or formed of fruits, seeds, leaves, roots, stems, and/or stalks, and comprises particularly preferably pectin-containing plant parts and/or uronic acid-containing marine plants. Examples of pectin-containing plant parts include citrus fruits as well as the infructescence of sunflowers, pears, apples, guavas, quinces, plums, and/or gooseberries. Also, residue resulting from juice production (pomace) is suitable. Examples of uronic acid-containing marine plants include in particular marine plants which are composed of polysaccharides containing uronic acid, such as algae, kelp, and seaweed. It is more strongly preferred in that context to use algae, the examples of which include, inter alia, brown algae, green algae, red algae, blue-green algae, and/or mixtures thereof. Brown algae, and in particular brown algae of the genera Ascophyllum, Durvillea, Eclonia, Fucus, Laminaria, Lessonia and Macrocystis, are considered to be especially preferred. Furthermore, it is particularly preferred according to the invention that the plant material is not mint or a part thereof, wherein concrete examples comprises, inter alia, spearmint, water mint, corn mint and/or peppermint.

The term “ion exchange capacity” as used herein can refer to the amount of zinc ions in mol that can be bound per gram of fiber. The definition of zinc ions results from the method of determination. Qualitatively, the ion exchange capacity can also be transferred to other metal ions, so that an increased capacity for zinc ions, for example, also means an increased capacity for magnesium ions, although not necessarily in the same amount.

In the next step of the inventive production process, the selected raw plant material is extracted using an extractant and, if necessary, post-treated to such an extent that water-soluble components such as mineral salts, which can disrupt the spinning process, are removed and only the water-insoluble framework structures of the plant remain. By removing mineral salts from the raw plant material, active centers for ion exchange are deblocked, which further increases the ion exchange capacity of the plant material. The preparation of the raw plant material is carried out by means of solid-liquid extraction, wherein the extractant preferably comprises water, an organic solvent, or a mixture of water and at least one organic solvent. More preferably, the extractant is water or a mixture of water and at least one organic solvent, and particularly preferably a mixture of water and at least one organic solvent.

Possible organic solvents are in particular protic solvents selected from the group consisting of alcohols, amines, amides and carboxylic acids, or/and aprotic polar solvents selected from the group consisting of ketones, lactones, lactams, nitriles, nitro compounds, tertiary carboxamides, sulfoxides, sulfones, and carboxylic esters. Concrete examples of protic solvents include methanol, ethanol, isopropanol, ethanolamine, ethylenediamine, formamide, formic acid, acetic acid, and propionic acid, but are not limited to these. Concrete examples of aprotic polar solvents include acetone, methyl ethyl ketone, gamma-Butyrolactone, N-methyl-2-5 pyrrolidone, acetonitrile, nitromethane, dimethylformamide, dimethylacetamide, dimethyl sulfoxide, sulfolane, dimethyl carbonate and ethylene carbonate.

If the extractant used is a mixture of water and at least one organic solvent, the proportion of organic solvent is preferably 10 to 80 wt.-%, calculated on the basis of the total weight of the solvent mixtures. The upper limit of the proportion of organic solvent is naturally limited by existing mixing limits of the organic solvent with water. More strongly preferred, the proportion of organic solvents is in the range of 20 to 70 wt.-%, and particularly preferably in the range of 30 to 60 wt.-%, calculated on the basis of the total weight of the solvent mixture.

The extraction as such can be carried out continuously or discontinuously. Discontinuous extraction is carried out in a temperature range between 0° and the boiling point of the solvent/solvent mixture. For this purpose, the raw plant material can, for example, be introduced into a Soxhlet sleeve, and can be extracted under reflux of the solvent using an apparatus comprising a Soxhlet extractor. In this way, extracted polymer-bound uronic acid-containing plant material is obtained, which is typically dried and ground for further processing. Surprisingly, the plant material obtained by extraction can be ground very well.

The term “extracted, polymer-bound uronic acid-containing plant material” as used herein thus can refer to the extraction residue which is obtained after extracting the respective raw plant material using the extractant and contains the components of the raw plant material that do not dissolve in the extractant. In contrast, by definition, the extract contains those components of the raw plant material which dissolve in the extractant under the specified reaction conditions, such as mineral salts and water-soluble uronic acid derivatives comprising alginic acid and sodium alginate.

In the last step of the inventive production process, the extracted polymer-bound uronic acid-containing plant material is combined with cellulose with the provision of a spinning solution, and the spinning solution is spun to cellulosic functional fibers in accordance with known methods. In particular, the present invention provides the production of cellulosic functional fibers in accordance with the lyocell process, wherein the extracted polymer-bound uronic acid-containing plant material, for example, is added to a cellulose and N methylmorpholine N-oxide monohydrate-containing spinning solution, and the resulting spinning solution is subsequently spun under suitable conditions to filaments, fibers, or films. Accordingly, it is particularly preferred according to the invention that the spinning solution contains neither the extract which is obtained as a by-product in the course of the raw plant material extraction nor material obtained by processing or cleaning the extract. By not further using the extract, the fiber production process can be simplified, and production costs can be decisively lowered due to an increase in the interval between maintenance work and production throughput.

The proportion of the extracted polymer-bound uronic acid-containing plant material in the spinning solution to be spun can be adjusted by the skilled person as required according to the respective requirements for the final textile product, but preferably amounts to 0.1 to 15 wt.-%, calculated on the basis of the weight of the cellulose contained in the spinning solution. More preferably, the proportion of the extracted polymer-bound uronic acid-containing plant material in the spinning solution is in the range of 1.0 to 10 wt.-%, and particularly preferably in the range of 2.5 to 7.5 wt.-%, calculated on the basis of the weight of the cellulose contained in the spinning solution.

If the solvent added to the spinning solution (e.g., N-methylmorpholine-N-oxide monohydrate) is recycled, as a result of the inventive extraction of the raw plant material with suitable extractants, an accumulation of mineral salts or soluble organic components can be mostly avoided in the system, by which cleaning-related maintenance work can be reduced and production throughput increased. Furthermore, the process may be easily applied to existing production plants for cellulosic fibers.

The cellulosic functional fibers produced by means of the inventive process can advantageously be used for producing yarns, twists, ropes, fabrics, knitted or crocheted fabrics, meshes, nonwovens, felts, and other textile products, wherein the fibers transfer their functionality to the entire textile product. The textile product, in turn, can be further processed in an appropriate manner, and can in particular serve for producing garments, pieces of furniture (especially upholstery) or carpets. Textile products containing or made from these fibers are characterized by a similarly high wearing comfort and better ion binding properties than cellulosic functional fibers, which contain proportions of untreated natural products. In addition, the cellulosic functional fibers produced by the inventive process also have properties similar to fibers produced conventionally according to the lyocell process, and they can be processed to produce textiles using comparable technology.

These properties are presumably related to the fact that the cellulosic functional fibers produced according to the invention contain polymer-bound, cellulose-immobilized uronic acids such as α-L-guluronate and β-D-mannuronate, the pKa values of which blend surprisingly well with the pH of the skin, and that the active centers of the uronic acids responsible for ion exchange are easily accessible by targeted separation of mineral salts, which typically leads to an ion exchange capacity of at least 60 μmol/g. Preferably, the ion exchange capacity of the cellulosic functional fibers produced according to the invention is at least 65 μmol/g, and particularly preferably at least 70 μmol/g.

Surprisingly, the ion exchange capacity of the cellulosic functional fibers described herein can be, at least preliminary, i.e., preliminarily, or permanently, further increased by selectively supplying either the spinning solution itself or the cellulosic functional fibers obtained after spinning the spinning solution with an alkaline earth metal salt or zinc salt having a water solubility of at least 100 g/l at 20° C., preferably a magnesium salt, calcium salt or zinc salt having a water solubility of at least 100 g/l at 20° C., more strongly preferred a magnesium salt or calcium salt having a water solubility of at least 100 g/l at 20° C., and particularly preferred calcium chloride.

If such an alkaline earth metal salt or zinc salt, preferably such a magnesium salt, calcium salt or zinc salt, more strongly preferred such a magnesium salt or calcium salt, and particularly preferred calcium chloride is added directly to the spinning solution, the ion exchange capacity of the cellulosic functional fibers increases noticeably to usually at least 75 μmol/g. For this purpose, the spinning solution can, for example, further comprise 0.5 to 5 wt.-% of alkaline earth metal salt or zinc salt, preferably a magnesium salt, calcium salt or zinc salt, more strongly preferred a magnesium salt or calcium salt and particularly preferred calcium chloride, calculated on the basis of the weight of the cellulose contained in the spinning solution. If using an alkaline earth metal such as calcium chloride or a zinc salt, the proportion of salt in the spinning solution is preferably in the range of 1.0 to 3.5 wt.-%, and particularly preferably in the range of 1.5 to 3.0 wt.-%, calculated on the basis of the weight of the cellulose contained in the spinning solution. By washing a cellulosic functional fiber produced in this way with household laundry detergent, the ion exchange capacity of the fiber can be increased even further.

Alternatively, the cellulosic functional fiber obtained after spinning the spinning solution can be subsequently treated (e.g., saturated) with an aqueous solution of an alkaline earth metal or a zinc salt having a water solubility of at least 100 g/l at 20° C., preferably an aqueous solution of a magnesium salt, calcium salt or zinc salt having a water solubility of at least 100 g/l at 20° C., more strongly preferred an aqueous solution of a magnesium salt or calcium salt having a water solubility of at least 100 g/l at 20° C., and particularly preferably an aqueous solution of a calcium chloride solution. As a result, the initial ion exchange capacity of the cellulosic functional fiber increases noticeably to the usual at least 80 μmol/g. However, the ion exchange capacity of such a cellulosic functional fiber decreases with an increasing number of washes to the level of an untreated, additive-containing fiber. The concentration of alkaline earth metal salt or zinc salt, preferably magnesium salt, calcium salt or zinc salt, more strongly preferred magnesium salt or calcium salt and particularly preferably calcium chloride in the aqueous solution can be adjusted as needed by the skilled person, however, preferably amounts to 2 to 8 wt.-%, and more strongly preferred to 4 to 6 wt.-%.

In the following, the invention is described in more detail using examples. Unless otherwise noted, the chemicals used in the examples were in each case obtained from Sigma-Aldrich.

### Example 1

An algae powder from dried brown algae of the genus Laminaria (manufacturer: smartfiber AG) was extracted using Soxhlet. For this purpose, 1 g of the algae powder was weighed into a Soxhlet sleeve and extracted for 2 hours under reflux. As an extractant, first, water (ultrapure water) was used, and then a water/ethanol mixture in the mass ratio 70:30. The algae material obtained after extraction was dried in each case and then analyzed by elemental analysis in terms of selective chemical elements.

The content of carbon (C), hydrogen (H), nitrogen (N) and sulfur (S) was determined in each case according to the manufacturer's specifications on a Euro Elemental Analyser of HEKAtech GmbH.

The content of chlorine (CI) and iodine (I) are determined, for chlorine in agreement with, or for iodine in accordance with, DIN EN ISO 10304-1:2009-07 on an ICS-900 ion chromatography system by Thermo Fisher Scientific Inc.

The content of sodium (Na), potassium (K), calcium (Ca), magnesium (Mg) and iron (Fe) was determined in accordance with DIN EN ISO 11885:2009-09 on an iCAP™ 7400 ICP-OES Analyzer by Thermo Fisher Scientific Inc.

The results of the elemental analyses are presented in Tables 1 and 2.

TABLE 1

| | C | H | N | s | Cl | I |
|---|---|---|---|---|---|---|
| | [%] | | | | [mg/kg] | |
| Algae powder, before extraction | | | | | 19000 | <500 |
| Algae powder, after extraction | 37.60 | 4.80 | 1.37 | 2.05 | 6500 | <500 |
| with H₂O | | | | | | |
| Algae powder, after extraction | 36.04 | 4.43 | 1.35 | 2.35 | 1600 | <500 |
| with H₂O/EtOH (70:30) | | | | | | |

TABLE 2

| | Well | K | Ca | Mg | Fe |
|---|---|---|---|---|---|
| Algae powder, before | 23600 | 13200 | 54600 | 8540 | 892 |
| extraction | | | | | |
| Algae powder, after | 240 | 116 | 17 | 14 | <0.014 |
| extraction with H₂0 | | | | | |
| Algae powder, after | 320 | 118 | 9.3 | 22 | <0.014 |
| extraction with H₂0/EtOH | | | | | |
| (70:30) | | | | | |

### Example 2

A suspension is produced consisting of 6 wt.-% cellulose with a Cuoxam-DP of 615 (manufacturer: Domsjö Fabriker AB), 52.5 wt.-% N-Methylmorpholine-N-oxide Monohydrate (NMMO) (manufacturer: OQEMA AG) and 41.5 wt.-% water. A solution is produced from this suspension by shear and water evaporation at a temperature of 95° C. and a pressure of 70 mbar, which is then pressed through a fiber spinneret, brought through an air gap into a spinning bath, and then drawn off. This is followed by leaching of the solvent, lubrication, cutting, and drying of the obtained cellulosic functional fiber (fiber 1: lyocell fiber).

### Example 3

The process described in Example 2 for producing a cellulosic functional fiber according to the lyocell process was repeated, except that 5 wt.-% (calculated on the basis of the weight of the cellulose contained in the spinning solution) of the untreated algae powder used in Example 1 were added to the spinning solution as starting material. After spinning and post-treatment, a cellulosic functional fiber containing uronic acid has been obtained (fiber 2).

### Example 4

The process described in Example 2 for producing a cellulosic functional fiber according to the lyocell process was repeated, except that 5 wt.-% (calculated on the basis of the weight of the cellulose contained in the spinning solution) of the algae powder obtained in Example 1, which was extracted using water, was added to the spinning solution. After spinning and post-treatment, uronic acid-containing cellulosic functional fiber (fiber 3) was obtained.

### Example 5

The process described in Example 2 for producing a cellulosic functional fiber according to the lyocell process was repeated, except that 5 wt.-% (calculated on the basis of the weight of the cellulose contained in the spinning solution) of the algae powder obtained in Example 1, which was extracted using water/ethanol by a mass ratio of 70:30, was added to the spinning solution. After spinning and post-treatment, uronic acid-containing cellulosic functional fiber (fiber 4) was obtained.

The cellulosic functional fibers produced in Examples 2 to 5 were then tested for their coloring, their textile physical values, their water retention, and their ion exchange capacity. It was found that the different cellulosic functional fibers do not differ in coloring.

The fiber fineness was determined in accordance with DIN EN ISO 1973:1995-12.

The maximum breaking force, the variation coefficients of the maximum breaking force, the elongation at maximum break, the breaking strength, the coefficient of variation of the breaking strength, the fineness-related loop breaking strength and the A-module were determined in accordance with DIN EN ISO 5079:1996-02 on a Z005 Universal Testing Machine by ZwickRoell GmbH & Co. KG.

The water retention capacity was determined in accordance with DIN 53814:1974-10.

The ion exchange capacity was determined using washed and dried fibers and by carrying out steps 1 to 4 described in more detail below.

Step 1: Ash Removal

To remove metal ions, about 5 g of finely chopped fibers were opened in about 200 ml of a 0.1 to 0.2 N hydrochloric acid with an Ultra-Turrax Stirrer and stirred for 2 hours with a magnetic stirrer. The cellulose was then drawn off via a G2 frit, washed neutrally with water, and air-dried. The dry content of these deashed air-dry fibers was determined.

Step 2: Reaction with Zinc Acetate

For the exchange of hydrogen ions for zinc ions, 1 g of deashed fibers (weight mE) with a known dry content were mixed in an Erlenmeyer flask with 50 ml of a 0.02 N zinc acetate solution and closed with a stopper. The fiber samples remained in the zinc acetate solution for 24 hours and were shaken for at least 5 of those hours (shaking table).

Step 3: Titration

In order to determine the decrease in zinc ion concentration in the added zinc acetate solution, the fiber pulp was again vigorously shaken before titration and drawn off via a dry G3 frit. 25 ml of the filtrate were mixed with 5 ml NH₃/NH₄Cl buffer solution (pH 10) and indicator titration (Eriochrome Black T) up to the red-violet color was added to the solution. With 0.01 N complexone solution, titration was performed to blue until the color changed (Consumption b). In a separate sample, 25 ml of the used zinc acetate solution titrated under the same conditions with 0.01 N complexone solution (Consumption a).

Step 4: Calculation of the Ion Exchange Capacity.

The calculation of the ion exchange capacity of the respective cellulosic functional fiber was carried out in accordance with the following formula:

$$Ion exchange capacity [ μ mol / g ] = \frac{40 ( a - b )}{{m}_{E} \frac{TG}{100}}$$

wherein m_{E}=weight of sample [g], TG=dry content [%], b=complexone consumption of the sample solution [ml], and a=complexone consumption of the zinc acetate solution [ml].

The results of the determination of the textile physical values, water retention and ion exchange capacity are given in Table 3.

TABLE 3

| | Fiber | Fiber | Fiber | Fiber |
|---|---|---|---|---|
| | 1 | 2 | 3 | 4 |
| Fiber fineness, gravimetric | 1.67 | 1.76 | 1.70 | 1.72 |
| (Mean value of 10 × 50 fibers) | | | | |
| [dtex] | | | | |
| Maximum breaking force (HZK) | 7.27 | 6.79 | 6.72 | 6.48 |
| [cN] | | | | |
| Coefficient of variation of the | 17.3 | 12.7 | 15.0 | 13.6 |
| maximum breaking force [%] | | | | |
| Elongation at maximum break [%] | 12.72 | 13.6 | 13.7 | 14.2 |
| Breaking strength [cN/tex] | 43.5 | 38.4 | 39.8 | 37.7 |
| Coefficient of variation of breaking | 14.7 | 12.7 | 15.0 | 13.6 |
| strength [%] | | | | |
| Fineness-related loop breaking | 11.2 | 11.4 | 11.1 | 12.8 |
| strength [cN/tex] | | | | |
| A-Module 0.5-0.7% [cN/tex] | 887 | 899 | 913 | 795 |
| Water retention capacity [%] | 68.1 | 66.2 | 67.2 | 67.0 |
| Ion exchange capacity [μmol/g] | 8 | 55 | 61 | 71 |

As can be seen from Table 3, the textile physical parameters of the cellulosic functional fibers, to which polymer-bound uronic acids were added in the form of algae powder, were all in the normal range of variance of lyocell fibers. As far as ion exchange capacity is concerned, it was found that an addition of 5 wt.-% of algae powder, calculated on the basis of the weight of the cellulose contained in the spinning solution, already leads to a significant increase in the ion exchange capacity. When untreated algae powder was used, the ion exchange capacity increased 7-fold (see Fiber 2), when algae powder after extraction with water was used, it increased 7.5-fold (see fiber 3), and when algae powder after extraction with water/ethanol mixture was used, to 9 times (see fiber 4) the value of the fiber 1 that was not mixed with algae powder.

### Example 6

The process described in Example 4 for producing a cellulosic functional fiber according to the lyocell process was repeated, except that 1.8 wt.-% (calculated on the basis of the weight of the cellulose contained in the spinning solution) of calcium chloride were added to the spinning solution. After spinning and post-treatment, uronic acid-containing cellulosic functional fiber (fiber 5) was obtained. The ion exchange capacity of this fiber was at 78 μmol/g and was thus about 10 times the value of the fiber that was not mixed with algae powder 1.

### Example 7

The cellulosic functional fibers obtained in Examples 2 to 6 were subjected to 25 household washes with detergent, and then re-examined in regard to their ion exchange capacity. The results are shown in Table 4.

TABLE 4

Ion exchange capacity [μmol/g]

| | | |
|---|---|---|
| Number of washes | 0 | 25 |
| Fiber 1 (untreated) | 8 | 1 |
| Fiber 2 (untreated) | 55 | 69 |
| Fiber 3 (untreated) | 61 | 77 |
| Fiber 4 (untreated) | 71 | 84 |
| Fiber 5 (untreated) | 78 | 84 |

As can be seen from Table 4, the ion exchange capacity of a conventional, uronic acid-free cellulosic functional fiber produced according to the lyocell process is reduced after repeated washing (see fiber 1). On the other hand, the cellulosic functional fibers mixed with algae powder each have higher ion exchange capacity after 25 household washes than the corresponding unwashed fibers (see fibers 2 to 5). This is probably due to an increasing fibrillation of the fibers, whereby further active centers for ionic bonding become accessible.

### Example 8

The cellulosic functional fibers obtained in Examples 3 to 5 were each treated (saturated) with a 5 wt.-% aqueous calcium chloride solution and then dried. The fibers obtained in this way were then examined, before and after 25 household washes with laundry detergent, with regard to their ion exchange capacity. The results are shown in Table 5.

TABLE 5

Ion exchange capacity [μmol/g]

| | | |
|---|---|---|
| Number of washes | 0 | 25 |
| Fiber 2 (saturated with CaCl₂) | 74 | 62 |
| Fiber 3 (saturated with CaCl₂) | 82 | 77 |
| Fiber 4 (saturated with CaCl₂) | 95 | 81 |

As can be seen from Table 5, when cellulosic functional fibers are saturated with CaCl₂), an immediate increase in ion exchange capacity is observed as compared to untreated fibers. However, this effect of post-treatment is no longer significant after 25 washes with detergent.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A process for producing a cellulosic functional fiber, comprising the steps of:
providing a raw plant material containing polymer-bound uronic acids;
extracting the raw plant material using an extractant in order to provide extracted polymer-bound uronic acid-containing plant material;
providing a spinning solution comprising cellulose and the extracted, polymer-bound uronic acid-containing plant material; and
spinning the spinning solution,
wherein the extracted polymer-bound uronic acid-containing plant material is an extraction residue which is obtained after extraction of the raw plant material using the extractant and which contains the components of the raw plant material that do not dissolve in the extractant.

2. The process for preparing a cellulosic functional fiber according to claim 1, wherein the raw plant material is selected from fruits, seeds, leaves, roots, stems, and/or stalks.

3. The process for preparing a cellulosic functional fiber according to claim 1, wherein the raw plant material comes from marine plants, which are composed of polymer-bound uronic acids.

4. The process for preparing a cellulosic functional fiber according to claim 1, wherein the extractant comprises water, an organic solvent, or a mixture of water and at least one organic solvent.

5. The process for preparing a cellulosic functional fiber according to claim 4, wherein the organic solvent is a protic solvent selected from the group: alcohols, amines, amides and carboxylic acids, and/or an aprotic-polar solvent selected from the group: ketones, lactones, lactams, nitriles, nitro compounds, tertiary carboxamides, sulfoxides, sulfones, and/or carboxylic esters.

6. The process for preparing a cellulosic functional fiber according to claim 1, wherein the proportion of the extracted, polymer-bound uronic acid-containing plant material in the spinning solution is 0.1 to 15 wt.-%, calculated on the basis of the weight of the cellulose contained in the spinning solution.

7. The process for preparing a cellulosic functional fiber according to claim 1, wherein the cellulosic functional fiber is produced in accordance with the lyocell process.

8. The process for preparing a cellulosic functional fiber according to claim 1, wherein the spinning solution further comprises 0.5 to 5 wt.-% of an alkaline earth metal salt or zinc salt having a water solubility of at least 100 g/l at 20° C., calculated on the basis of the weight of the cellulose contained in the spinning solution.

9. The process for preparing a cellulosic functional fiber according to claim 1, wherein the process further comprises treating the cellulosic functional fiber obtained by spinning the spinning solution with a 2 to 8% aqueous solution of an alkaline earth metal salt or zinc salt having a water solubility of at least 100 g/l at 20° C.

10. The process for preparing a cellulosic functional fiber according to claim 8, wherein the alkaline earth metal salt or zinc salt having a water solubility of at least 100 g/l at 20° C. is a calcium chloride.

11. A cellulosic functional fiber produced by the process according to claim 1.

12. A textile product comprising the cellulosic functional fiber according to claim 11.

13. The textile product according to claim 12, wherein the textile product is a yarn, a twist, a rope, a fabric, a knitted or crocheted fabric, a mesh, a nonwoven or a felt.

14. A garment comprising the cellulosic functional fiber according to claim 11.

15. A piece of furniture comprising the cellulosic functional fiber according to claim 11.
